(19) United States
(12) Patent Application Publication
(10) Pub. No.: US 2025/0147260 A1
(43) Pub. Date: May 8, 2025

(54) PRETERMINATED NETWORK CABLE APPARATUS, SYSTEMS, AND METHODS

(71) Applicant: viaPhoton, Inc., Aurora, IL (US)

(72) Inventors: Mark James SMRHA, Chicago, IL (US); Keith Samuel MARANTO, Frankfort, IL (US); Walter Mark HENDRIX, Dallas, TX (US); Nathan Eric BENTON, Dallas, TX (US); Jeffrey Earl JONES, SR., Stewartstown, PA (US); Christopher Brian HASLEY, Gibsonia, PA (US)

(21) Appl. No.: 18/938,870

(22) Filed: Nov. 6, 2024

Related U.S. Application Data
(60) Provisional application No. 63/596,560, filed on Nov. 6, 2023.

(51) Int. Cl. G02B 6/44; G02B 6/46

(52) U.S. Cl. CPC G02B 6/4458; G02B 6/4452; G02B 6/47

(57) ABSTRACT

Methods and apparatus are provided for installing trunk cables in a data center. A set of trunk cables, wound on a rotatable cable reel, is provided. The set of trunk cables comprises a first set of fiber modules connected to respective first ends of the set of trunk cables, wherein the first set of fiber modules are preloaded into the fiber panel removably secured to the cable reel. The cable reel is positioned a first connection point in the data center. A second set of fiber modules, connected to respective second ends of the set of trunk cables, is pulled from the cable reel to a second connection point. The fiber panel corotates with the cable reel during payout of the set of trunk cables. The fiber panel is then secured to data center equipment at the first connection point.

### CROSS-REFERENCE TO RELATED APPLICATIONS

This application claims the benefit of U.S. Provisional Application Ser. No. 63/596,560, filed Nov. 6, 2023, which is hereby incorporated by reference for all purposes.

### BACKGROUND

In modern data centers, the demand for high-capacity and reliable connectivity solutions has become increasingly critical. Data centers, especially in the case of hyperscale data centers, are required to support applications like artificial intelligence, machine learning, and associated massive data processing, all of which necessitate high-speed, low-latency communication. Traditionally, data centers have relied on fiber optic trunk cables to interconnect servers, storage, and networking equipment. These cables typically feature single or multifiber connectors that are manually installed at both ends, requiring careful handling when being pulled through cable conveyances to avoid damage to fiber connectors.

Current data center installations involve the manual pulling of fiber trunk cables through cable trays or ducts from one connection point to another. This process includes attaching a pulling sock to the fiber cable and pulling the cable through the tray, followed by unpacking and preparing the cable for connection.

With the ongoing expansion of data centers and the growing complexity of their infrastructure, the industry is searching for methods to streamline the fiber installation process while improving reliability and reducing labor requirements. The need for efficient, scalable solutions is becoming more urgent as the volume of fiber installations grows in line with demand for faster, higher-capacity networks.

The manual processes of installation, including cleaning, connecting, and assessing the cables, are time-consuming and prone to errors, leading to delays and potential rework. The manual steps introduce several challenges, including the risk of connector contamination, fiber damage, and connection errors. Furthermore, the use of pulling socks and additional protective materials generates waste and adds complexity to the process. These factors collectively contribute to higher labor costs, longer installation times, and increased risks of network downtime during the deployment phase.

### SUMMARY

In general, in one or more aspects, the disclosure relates to an apparatus. The apparatus a set of trunk cables wound around the cable reel. Each trunk cable comprises a first end and a second end. A first set of fiber modules is connected to respective first ends of the set of trunk cables. A second set of fiber modules is connected to respective second ends of the set of trunk cable. The connections between the fiber module and the trunk cable are pre-terminated connections that do not include a plug interface between the trunk cable and a rear of the fiber module.

In general, in one or more aspects, the disclosure relates to a method for installing trunk cables in a data center. A set of trunk cables, wound on a rotatable cable reel, is provided. The set of trunk cables comprises a first set of fiber modules connected to respective first ends of the set of trunk cables, wherein the first set of fiber modules are preloaded into the fiber panel removably secured to the cable reel. The cable reel is positioned a first connection point in the data center. A second set of fiber modules, connected to respective second ends of the set of trunk cables, is pulled from the cable reel to a second connection point. The fiber panel corotates with the cable reel during payout of the set of trunk cables. The fiber panel is then secured to data center equipment at the first connection point.

Other aspects of the invention will be apparent from the following description and the appended claims.

### BRIEF DESCRIPTION OF DRAWINGS

FIG. 1 shows a payout system for pre-terminated datacenter trunk cables in accordance with one or more embodiments of the invention.

FIG. 2 shows a fiber panel in accordance with one or more embodiments of the invention.

FIG. 3 shows an assembly of linked containers in accordance with one or more embodiments of the invention.

FIG. 4 shows a pulling container in accordance with one or more embodiments of the invention.

FIG. 5 shows an exploded view of the pulling container(s) in accordance with one or more embodiments of the invention.

FIG. 6 shows housing segments of a pulling container(s) in accordance with one or more embodiments of the invention.

FIGS. 7A and 7B show a partially assembled view of the housing segments in accordance with one or more embodiments of the invention.

FIG. 8 shows a method in accordance with one or more embodiments of the invention.

Like elements in the various figures are denoted by like reference numerals for consistency.

### DETAILED DESCRIPTION

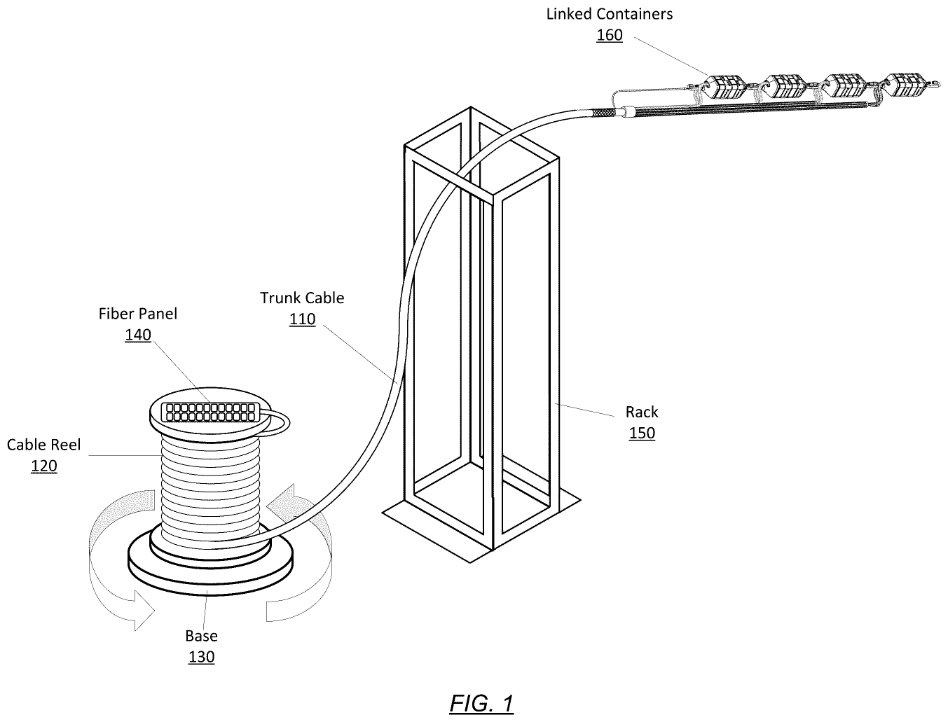

Turning to FIG. 1, a payout system for pre-terminated datacenter trunk cables is shown according to illustrative embodiments.

The trunk cable (110) is a high-capacity fiber optic cable that connects various data center components. The trunk cable provides the high-speed optical connections between network devices within the data center, ensuring low-latency data transmission. The trunk cable (110) typically contains multiple individual optical fibers, which may be housed within a protective sheath. The trunk cable is made of silica glass, which is encased in several layers of protective materials, such as buffer tubes, strength members, and a polyethylene outer jacket.

The cable is pre-terminated, meaning it comes with connectors already attached to both ends, eliminating the need for on-site termination. The trunk cable is pre-terminated at both ends to eliminate the need for field termination, reducing potential errors and installation time.

The trunk cable (110) is rotatably mounted on the cable reel (120). The cable reel (120) is a mechanical cylindrical component designed to hold and dispense the fiber trunk cable. The reel is designed to carry a pre-terminated fiber trunk cable, coiled around its circumference for storage. The cable reel is typically made from durable materials, such as steel, wood, or heavy-duty plastic, to support the weight of high fiber-count cables. As the reel spins, trunk cable stored on the reel is paid out for distribution through the data center.

The reel is mounted on a base (130), which supports its vertical positioning and rotational movement of the reel. Base (130) allows the reel to rotate during cable payout, and may include bearings or a swivel to facilitate rotation.

The fiber panel (140) serves as the interface for the pre-terminated fiber modules. The fiber panel contains multiple connector slots where the pre-terminated fibers are stored and organized. It is mounted on top of the cable reel and in a position that allows seamless payout as the cable is deployed from the reel, simplifying the installation process. The fiber panel spins with the reel as the cable is paid out into the data center.

The fiber panel (140) is removably mounted on top of the cable reel and contains a plurality of the pre-terminated fiber modules that include standardized ports (such as LC, MPO, or VSFF (very small form factor) connectors), allowing for compatibility with common networking hardware. The panel is pre-assembled with the fiber trunk cable and remains attached to the cable during the payout process, ensuring that the pre-terminated fibers are protected and organized. Upon payout completion, the fiber panel is transferred to the designated rack for connection.

The rack (150) is a vertical framework used to house and organize the networking equipment and cables within the data center. The rack is designed to support the fiber panel once the trunk cable has been fully deployed. The rack is typically made from materials like steel or aluminum and is designed to hold a large amount of weight while remaining stable.

The rack dimensions are sized to accommodate different panels having with different form factors, such as 1U, 2U, or larger units, where “U” represents a standard rack unit of measure equal to 1.75 inches in height. The outer dimensions of rack (150) align with the widths of most network and server equipment. For example, rack width (104) may measure 19 inches (48.26 cm) or 23 inches (58.42 cm) in width, standard measurements that are adhered to in the telecommunications industry. Other dimensions may be used, e.g., 21 inches, 23 inches, etc.

The rack (150) may include a series of uniformly spaced vertical mounting slots, located on both the front and rear, which serve as attachment points for mounting panel(s) associated with telecommunication equipment. The mounting slots and brackets are compatible with data center equipment, having standardized spacing between the slots of the rack (150) ensuring that the fiber panel can be securely fastened.

The linked containers (160) are modular enclosures that house one or more pre-terminated fiber modules during payout. The pulling containers (310) are linked together via a flexible linkage, which allows the containers to move through bends and curves in the data center's cable trays or ducts. Multiple containers are connected in series to form a continuous chain, allowing multiple fiber modules to be pulled simultaneously during installation.

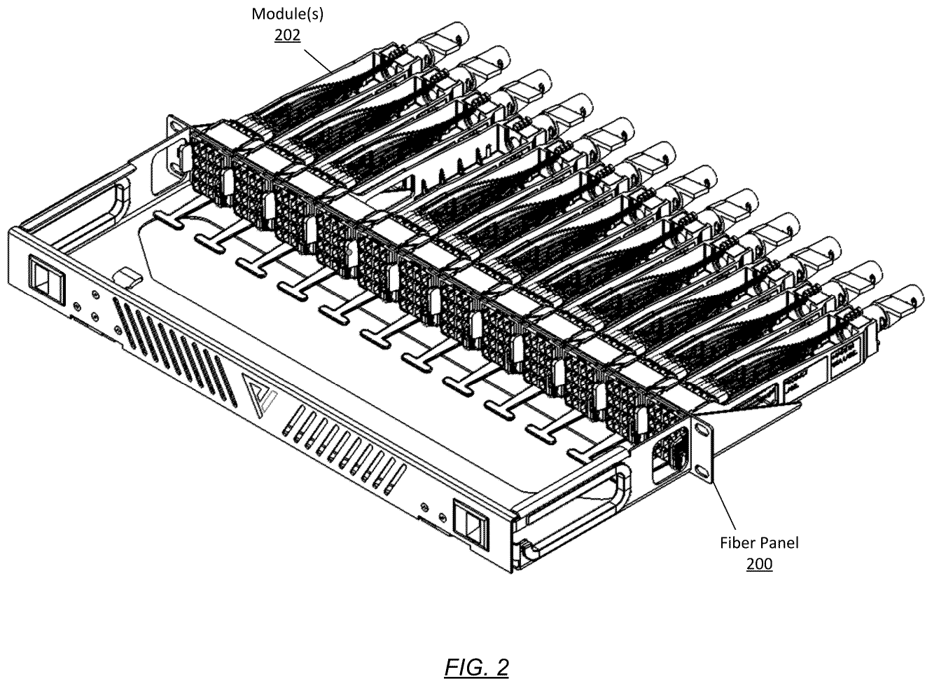

Turning to FIG. 2, a fiber panel is shown according to illustrative embodiments. The panel 200 is an example of fiber panel (140) of FIG. 1.

the panel (200) includes the modules (202). The modules (202) are front-loading modules. The modules, of a similar form factor, may also be rear loading. In one embodiment, the panel (200) may be configured to fit a 19-inch rack. In one embodiment, the panel (200) has a 1U panel height of about 1.75 inches (44.45 millimeters) and a width of about 19 inches (482.6 millimeters). In one embodiment, the panel (200) includes spaces for 12 of the modules (202). Each of the modules (202) includes multiple optical fiber couplers.

In one embodiment, each module (202) includes 16 LC (Lucent connector) couplers, and the panel (200) includes 192 optical couplers for a 19-inch rack. Additional modules and couplers may be included in panels for larger racks. For example, a panel for a 23-inch rack may include space for 14 modules and 224 couplers. Diverse types of couplers and connectors may be used in addition to LC couplers, including MPO (multi fiber push on) connectors, MTP (multi-fiber termination push-on) couplers, VSFF (very small form factor) connectors, etc.

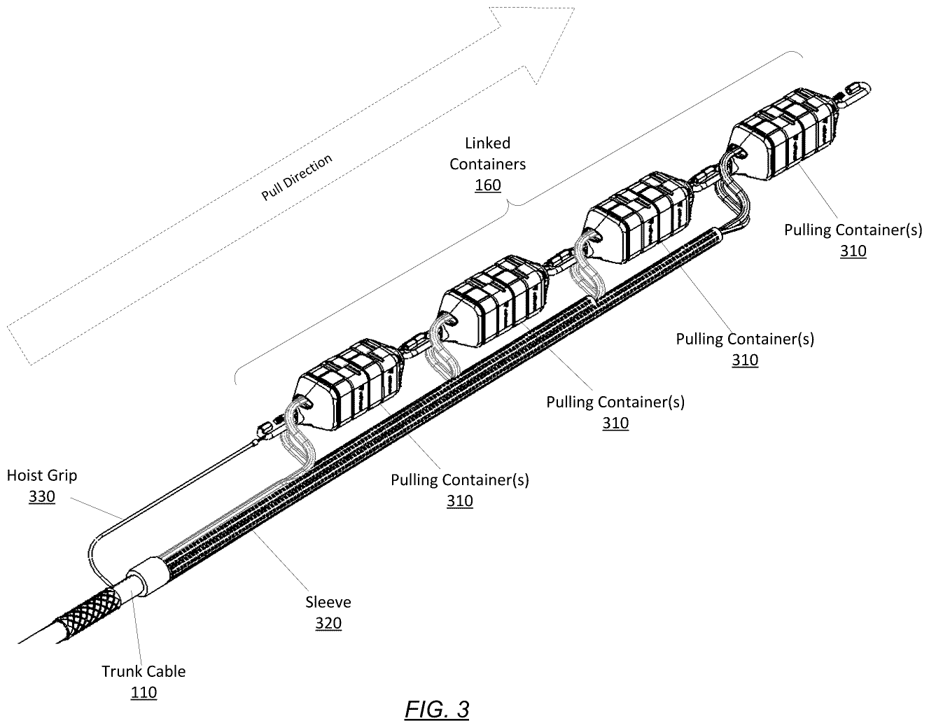

Referring to FIG. 3, the assembly of linked containers (160) includes the trunk cable (110). the trunk cable (110) includes cables that connect to modules housed within one or more pulling container(s) (310). The cables route from modules in the pulling container(s) (310), through exit holes to the trunk cable (110).

The pulling container(s) (310) are enclosures designed to protect fiber modules during the pulling process. These containers are typically constructed from durable materials, such as reinforced plastic or metal, to prevent damage to the fiber connectors during installation. Each pulling container features attachment points that allow them to be connected in series, ensuring that the entire length of the fiber trunk cable can be pulled as a single unit. These containers may also include padding or shock-absorbing features to further protect the internal components from impact or vibration.

In an embodiment, each of the pulling container(s) (310) may be loaded with twelve modules. The twelve modules for one of the pulling container(s) (310) may fill a panel. The panels, filled by the modules of the four-pulling container(s) (310), may fill three slots of a rack in a server cabinet. Other sizes of the pulling container are offered which, when full, support one, four, six, and other quantities of modules.

Multiple pulling container(s) (310) may be linked together using a linkage, such as a carabiner connected to a rear eyelet of the pulling container(s) (310). The linkage may connects between the pulling container(s) (310), as well as the hoist grip (330) to form the linked containers (160).

The hoist grip (330) is secured at the leading edge of the assembly, and transmits the pulling force along the length of the trunk cable and linked containers. The hoist grip (330) acts as a tension member, such as a rope, which connects to the trunk cable to transfer tension to the insulation of the trunk cable (110) without damaging the fibers or connectors housed within the linked containers. A sleeve (320) may locate proximal to the hoist grip to reinforce the trunk cable at adjacent to the hoist grip and distributes the tensile load.

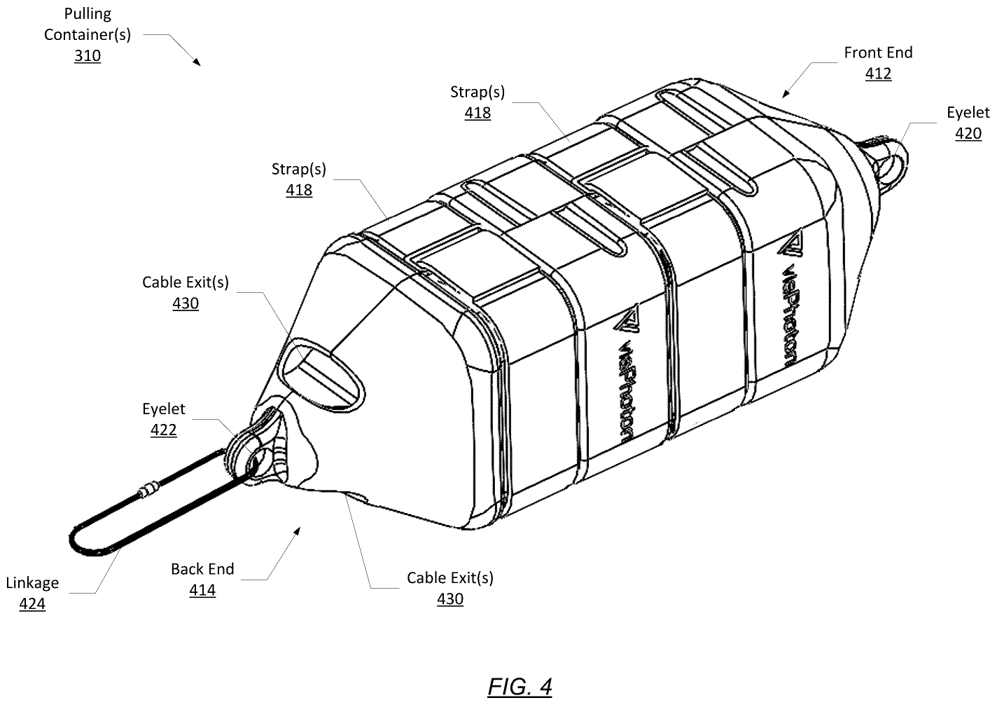

Turning to FIG. 4, the pulling container (310) is illustrated. The pulling container (310) includes the front eyelet (420), the tapered front end (412), the tapered back end (414), the cable exit(s) (430), the rear eyelet (422), and the linkage (424).

The front eyelet (420) may also be referred to as a front pulling eye. The front eyelet (420) provides an attachment point for the pulling container (310) to be pulled from one location to another by attaching a rope (or similar pulling method). The front eyelet (420) may also be used to connect additional containers to each other in succession by attaching the linkage (424) (e.g., a carabiner or similar attachment mechanism) to a rear eyelet of a container in front of the pulling container (310). Multiple containers may be connected together and pulled in succession.

The tapered front end (412) and the tapered back end (414) are angled surfaces. The tapered front end (412) and the tapered back end (414) reduce the chance of the pulling container (310) getting snagged on obstructions as the pulling container (310) moves through cable pathways and around obstacles.

The cable exit(s) (430) allow cables to exit the pulling container (310). The cable exit(s) (430) are positioned on two sides of the rear eyelet (422), which may be opposite sides, e.g., an upper side and a lower side.

Straps (418) (e.g., a hook-and-loop strap or similar strapping device) may be installed around the periphery of the pulling container (310). In some embodiments, the straps may be positioned into a recess in the housing so that the straps (418) do not fall off or get caught or snagged on obstructions during pulling.

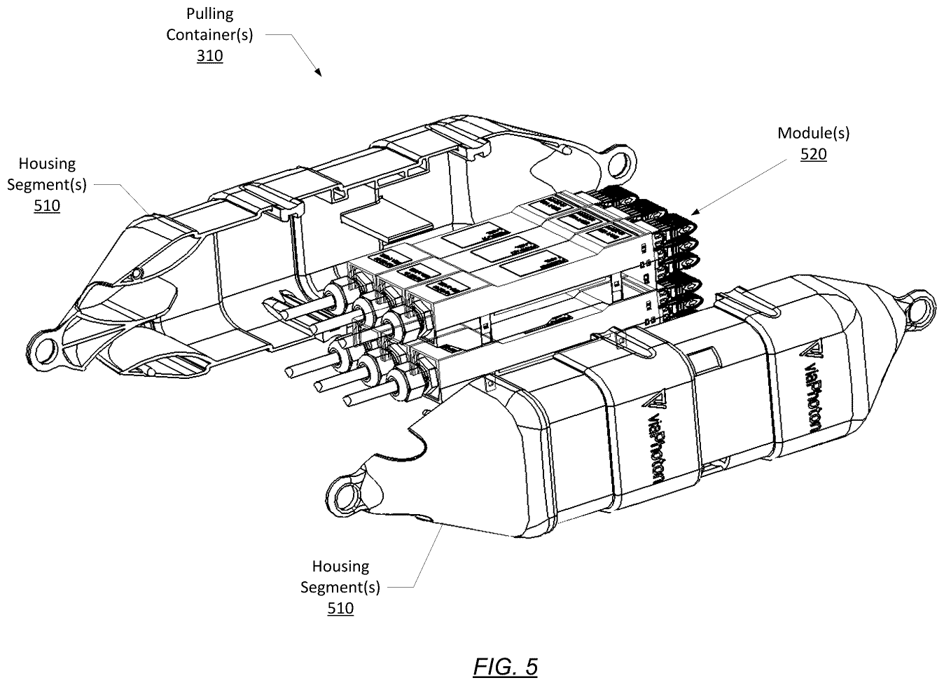

Referring now to FIG. 5, the pulling container(s) (310) is illustrated in an exploded view. the pulling container(s) (310) forms an outer shell and may be composed of multiple housing segments (510), i.e., two halves, which come together to form an enclosure to contain and protect multiple modules (520). When assembled, the pulling container(s) (310) encloses a bundle of modules(s) (520) between the housing segment(s) (510). The bundle of the modules(s) (520) is arranged in two rows with three modules per each row.

In an embodiment, the multiple housing segments (510) may be structurally the same and made with the same tooling. In other words, each housing segment(s) (510) may be identical to each other.

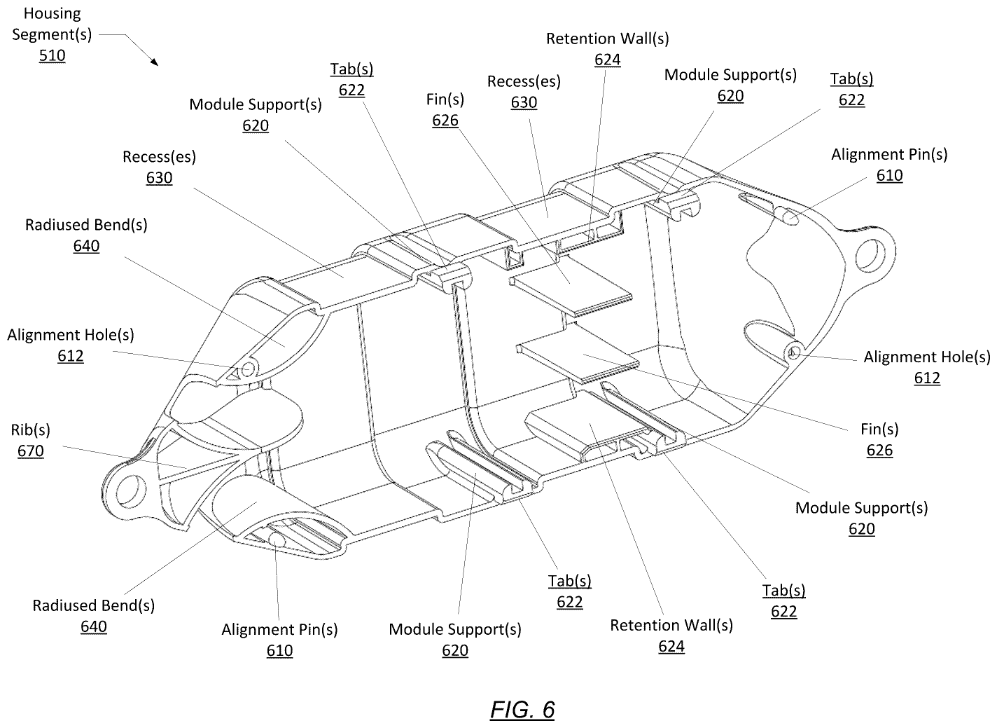

Turning to FIG. 6, housing segments (510) is shown according to an illustrative embodiment. housing segments (510) forms a half of a housing of a pulling container. The housing segments (510) comes together with another housing segments (510) to form an enclosure to contain and protect multiple modules. The housing segments (510) includes several components, features, and elements.

The alignment pins (610) are inserted into the alignment holes (612) to align the assembly of the housing segments (510) with another housing segment (not shown) that may be a copy of the housing segments (510). The front end of the housing segments (510) includes one of the alignment pins (610) and includes one of the alignment holes (612). The rear end of the housing segments (510) includes one of the alignment pins (610) and includes one of the alignment holes (612). The alignment pins (610) and the alignment holes (612) keep the surfaces of the housing segments (510) lined up with each other, even if forces are exerted on the surfaces of the outer shell.

The tabs (622) keep the surfaces of the housing segment(s) (510) aligned with another housing segment, even if forces are exerted on the surfaces. The tabs (622) are formed with the module support(s) (620). The tabs (622) extend out from the housing segment(s) (510) to secure into another housing segment(s) (not shown).

Retention members of the housing segments (510) include the module support(s) (620), fins (626), and retention walls (624), which support and align a bundle of modules in the housing segment(s) (510). The retention members also prevent the modules in the bundle from sliding back towards the rear end of the pulling container formed by the housing segment(s) (510) during pulling. The fins (626) slide between rows of the modules to secure the modules within the housing segment(s) (510) when the pulling container(s) (310) is assembled.

The cable guides (640) provide cable bend radius protection. Use of the cable guides (640) prevents cables from bending too tightly when exiting the pulling container formed with the housing segment(s) (510) through the cable exits(s) (430) to reduce the risk of damaging the cables.

The strength members, including the strength rib (670), are used to strengthen the components. Inclusion of the strength members reduces the risk of flexing or warping of the pulling container formed from the housing segment(s) (510).

Recess(es) (630) are locations on the housing segments (510) that are offset below the widest areas of the housing surface. The recess provides for fitment of the straps (418), keeping the straps (418) contained during pulling so that the straps (418) do not fall off or get caught or snagged on obstructions.

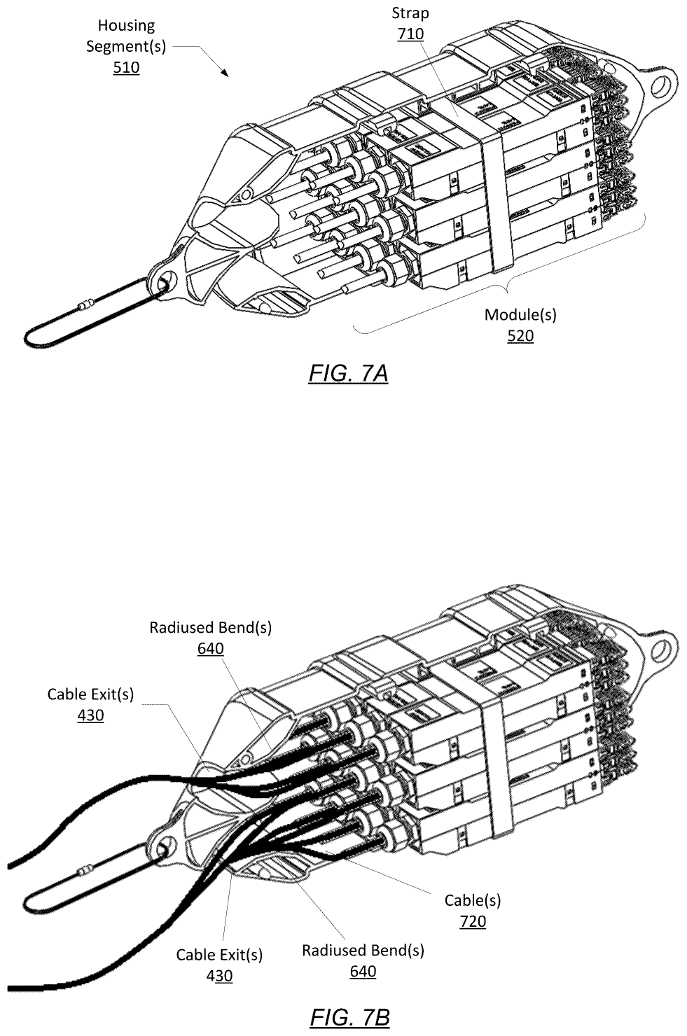

Turning to FIG. 7A, a partially assembled view of the housing segments (510) is illustrated. The housing segments (510) is fitted with twelve (12) modules (520) bundled inside, and secured together with strap (710). In an embodiment, the twelve modules may fill a row of a panel for a rack. Other sizes of the pulling container are offered which, when full, support one, four, six, and other quantities of modules.

The bundle of the modules (520) may be retained together using the bundle strap (710). Embodiments of the bundle strap (710) may include a hook-and-loop strap, cable ties, tape, etc. Using the bundle strap (710) keeps the modules (520) together and organized during assembly of the portions of the housing segments (510).

Turning to FIG. 7B, a partially assembled view of the housing segment (510) is illustrated. The cables (720) terminated by the modules (520) are routed around radiused bend(s) (640) and through the cable exit(s) (430).

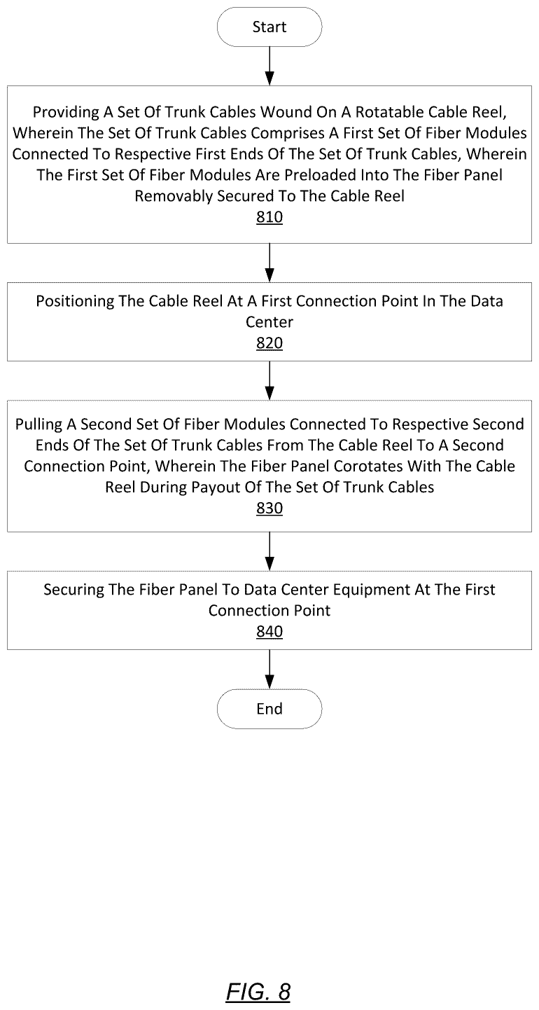

Turning now to FIG. 8, a method for installing trunk cables in a data center is shown in accordance with one or more embodiments of the invention.

Beginning at block 810, a set of trunk cables, wound on a rotatable cable reel, are provided. The set of trunk cables comprises a first set of fiber modules connected to respective first ends of the set of trunk cables. The first set of fiber modules are preloaded into the fiber panel removably secured to the cable reel.

In some embodiments, the cable reel is mounted on a rotatable base to allow free rotation during payout of the trunk cable. The fiber panel can be a 1U panel includes spaces for 12 fiber modules.

Each fiber module may comprise sixteen LC couplers, within a 1U height, of 192 couplers of a panel comprising a set of twelve modules including the module. Alternatively, the fiber module may comprise eight MPO couplers, within a 1U height, of 96 couplers of a panel comprising a set of twelve modules, including the module, providing 1152 fibers using the 96 couplers. Using VSFF connectors, 288 couplers are provided per module, providing 3456 fibers for the 1U panel.

At block 820, the cable reel is positioned at a first connection point in the data center. At block 830, a second set of fiber modules, connected to respective second ends of the set of trunk cables, is pulled from the cable reel to a second connection point, wherein the fiber panel corotates with the cable reel during payout of the set of trunk cables.

In some embodiments, the second set of fiber modules is encased within a set of pulling containers. Each pulling container may house a segment of the trunk cable with pre-terminated connectors. The set of pulling containers may then be interconnected by a set of linkages.

At block 840, the fiber panel is secured to data center equipment at the first connection point. At some point thereafter, the second set of fiber modules may be secured to data center equipment at the second connection point.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising:
a cable reel;
a set of trunk cables wound around the cable reel, wherein each trunk cable comprises a first end and a second end;
a first set of fiber modules connected to respective first ends of the set of trunk cables; and
a second set of fiber modules connected to respective second ends of the set of trunk cable;
wherein connections between the fiber module and the trunk cable are pre-terminated connections that do not include a plug interface between the trunk cable and a rear of the fiber module.

2. The apparatus of claim 1, wherein the fiber module comprises sixteen LC couplers, within a 1U height, of 192 couplers of a panel comprising a set of twelve modules.

3. The apparatus of claim 1, wherein the fiber module comprises eight 12-fiber MPO couplers per module for a fiber count of 96 fibers per module within a 1U height.

4. The apparatus of claim 1, wherein the fiber module comprises eighteen 16-fiber VSFF couplers per module for a fiber count of 288 fibers per module within a 1U height.

5. The apparatus of claim 1, further comprising:
a fiber panel removably secured to the cable reel, wherein the first set of fiber modules are preloaded into the fiber panel and the fiber panel corotates with the cable reel during payout of the set of trunk cables.

6. The apparatus of claim 5, wherein the fiber panel is a 1U panel that is securable to a rack.

7. The apparatus of claim 5, wherein the first set of fiber modules comprises a set of twelve modules preloaded into the fiber panel, each module having a fiber count of 96 fibers per module, thereby providing a providing fiber panel having 1152 fibers per panel using the 96 couplers per module.

8. The apparatus of claim 5, wherein the first set of fiber modules comprises a set of eighteen modules preloaded into the fiber panel, each module having a fiber count of 288 fibers per module, thereby providing a providing fiber panel having 3456 fibers per panel using the 288 couplers per module.

9. The apparatus of claim 5, wherein the fiber module comprises a plurality of couplers for fiber optic cables, of 288 couplers per module of a panel comprising a set of twelve modules,—thus providing 3456 fibers using the 288 couplers per module.

10. The apparatus of claim 1, further comprising a set of pulling containers, each pulling container comprising:
a set of housing segments structured to enclose the second set of fiber modules;
a front eyelet of the housing;
a tapered front end of the housing;
a back eyelet; and
one or more retention members structured to support the at least one module within the pulling container.

11. The apparatus of claim 10, further comprising:
the one or more retention members comprising a backplate comprising the back eyelet.

12. The apparatus of claim 10, further comprising:
an alignment tab of the housing; and
a slot of a backplate structured to receive the alignment tab.

13. A method for installing trunk cables in a data center, the method comprising:
providing a set of trunk cables wound on a rotatable cable reel, wherein the set of trunk cables comprises a first set of fiber modules connected to respective first ends of the set of trunk cables, wherein the first set of fiber modules are preloaded into the fiber panel removably secured to the cable reel;
positioning the cable reel at a first connection point in the data center;
pulling a second set of fiber modules connected to respective second ends of the set of trunk cables from the cable reel to a second connection point, wherein the fiber panel corotates with the cable reel during payout of the set of trunk cables; and
securing the fiber panel to data center equipment at the first connection point.

14. The method of claim 13, wherein the cable reel is mounted on a rotatable base to allow free rotation during payout of the trunk cable.

15. The method of claim 13, wherein the fiber panel is a 1U panel that is securable to a rack.

16. The method of claim 15, wherein the fiber module comprises sixteen LC couplers, within a 1U height, of 192 couplers of a panel comprising a set of twelve modules.

17. The method of claim 16, wherein the first set of fiber modules comprises a set of twelve modules preloaded into the fiber panel, each module having a fiber count of 96 fibers per module, such that the fiber panel provides 1152 fibers per panel using the 96 couplers per module.

18. The method of claim 15, wherein the fiber module comprises eight 12-fiber MPO couplers per module for a fiber count of 96 fibers per module within a 1U height.

19. The method of claim 18, wherein the first set of fiber modules comprises a set of eighteen modules preloaded into the fiber panel, each module having a fiber count of 288 fibers per module, such that the panel provides 3456 fibers per panel using the 288 couplers per module.

20. The method of claim 15, wherein the fiber module comprises eighteen 16-fiber VSFF couplers per module for a fiber count of 288 fibers per module within a 1U height.

21. The method of claim 18, wherein the fiber module comprises a plurality of couplers for fiber optic cables, of 288 couplers per module of a panel comprising a set of twelve modules,—such that the panel provides 3456 fibers per panel using the 288 couplers per module.

22. The method of claim 13, wherein pulling the second set of fiber modules further comprises:
encasing the second set of fiber modules within a set of pulling containers.

23. The method of claim 22, wherein pulling container houses a segment of the trunk cable with pre-terminated connectors.

24. The method of claim 22, further comprising:
interconnecting the set of pulling containers by a set of linkages.

25. The method of claim 13, further comprising:
securing the second set of fiber modules to data center equipment at the second connection point.
